(19) United States
(12) Patent Application Publication
(10) Pub. No.: US 2011/0211067 A1
(43) Pub. Date: Sep. 1, 2011

(54) SAMPLE ANALYSIS APPARATUS AND A METHOD OF ANALYSING A SAMPLE

(75) Inventors: Benjamin McKay, Amsterdam (NL); Dirk François Bentschap Knook, Amsterdam (NL); Stephan Olivier van Banning, Amsterdam (NL); Anita Coetzee, Amsterdam (NL)

(73) Assignee: AVANTIUM HOLDING B.V., Amsterdam (NL)

(21) Appl. No.: 13/127,281

(22) PCT Filed: Nov. 2, 2009
(86) PCT No.: PCT/NL2009/000208

§ 371 Date: May 16, 2011

(30) Foreign Application Priority Data
Nov. 11, 2008 (NL) 2002196

(51) Int. Cl. H04N 7/18

(52) U.S. Cl. 348/135; 348/E07.085

(57) ABSTRACT

The invention relates to a sample analysis apparatus. The apparatus comprises: a radiation system to irradiate the sample in a vial and an analyser with a camera to analyse the radiation received from the sample in the vial. The apparatus is provided with a holder to releasable hold the vial and with an optical path for the radiation system to irradiate the sample and for the camera to make images of the sample. The radiation system can be used for front lighting of the sample in the vial or for back lighting of the sample in the vial. The camera may be provided with a telecentric lens.

### CROSS-REFERENCE TO RELATED APPLICATIONS

This application is the National Stage of International Application No. PCT/NL2009/000208, filed Nov. 2, 2009, which claims the benefit of Netherlands Application No. NL 2002196, filed Nov. 11, 2008, the contents of which is incorporated by reference herein.

### FIELD OF THE INVENTION

The invention relates to a sample analysis apparatus comprising: at least one radiation system constructed and arranged to irradiate the sample in a vial; and an analyser provided with a camera constructed and arranged to analyse the radiation received from the sample in the vial. The invention also relates to a method of analysing a sample comprising: providing a vial with a sample releasable to a holder; and, irradiating the sample in the vial with radiation.

### BACKGROUND OF THE INVENTION

Sample analysis apparatus may be used for analysing samples such as fluids (e.g liquid and gasses) and/or suspensions. In a sample analysis apparatus according to the prior art a radiation system and an analyser may be provided in a vial to analyse the sample in the vial. A disadvantage may be that the sample may contaminate the sample analysis apparatus and/or that the sample analysis apparatus may contaminate the sample. If the sample analysis apparatus is used for analysing crystals growing in the vial the crystals may be growing on the sample analysis apparatus and thereby deteriorating the functioning of the sample analysis apparatus and/or the sample analysis apparatus may influence the growing of the crystals. Alternatively, for example according to NL1026306 the sample analysis apparatus may be mounted to a test tube. If the test tube is to be cleaned, the cleaner should take care not to damage the sample analysis apparatus.

### SUMMARY OF THE INVENTION

It is an object of the invention to provide an improved sample analysis apparatus and an improved method of analysing a sample.

According to the invention the sample analysis apparatus is provided with at least one radiation system constructed and arranged to irradiate the sample in a vial; an analyser provided with a camera constructed and arranged to analyse the radiation received from the sample in the vial, wherein the apparatus is provided with a holder constructed and arranged to releasable hold the vial and provided with an optical path for the radiation system to irradiate the sample and for the camera to make images of the sample, wherein the camera comprises a telecentric lens and a detector.

By having the sample in the vial and holding the sample releasable in the holder it becomes easier to clean the vial after analysing the sample because the vial can be separated from the sample analysis apparatus. The sample in the vial will also not be contaminated by the sample analysis apparatus because it is kept in the vial. Crystals growing in the vial may not be influenced by the sample analysis apparatus because the crystal are kept in the vial and are not in contact with the sample analysis apparatus. The throughput of the sample analysis apparatus is also improved because it is easy to exchange a vial in the holder for the next vial. By using a telecentric lens the size and shape of an image formed of the sample is independent of the distance or position to the sample, which is advantageous for imaging particles that may be moving in the vial.

According to a further embodiment the at least one radiation system comprises a radiation source, for example a light emitting diode. The at least one radiation system may irradiate the sample in the vial with pulsed irradiation. The pulsed irradiation may make standstill images of the sample if the sample is moving in the vial, for example caused by stirring in the sample. The at least one radiation system comprises a diffuser for ensuring a uniform irradiation of the sample in the vial.

According to a further embodiment of the invention the holder comprises a temperature control system provided with a thermometer for controlling the temperature of the vial. The temperature control system may comprise a heater for heating the vial and/or a cooler for cooling the vial.

According to a further embodiment the holder is provided with a hole for releasing or receiving the vial. The at least one radiation system and the camera are constructed and arranged opposite each other with the hole in between so that the at least one radiation system is irradiating the camera with radiation traversing through the vial in the hole.

According to a further embodiment the at least one radiation system and the camera may be arranged on the same side of the hole and the at least one radiation system is arranged for irradiating the sample in the vial from the same direction as the camera is arranged for making images of radiation diffuse reflected form the sample in the vial. The at least one radiation system may comprise a semitransparent mirror arranged between the camera and the hole so as to irradiate the sample in the vial from the same direction as the camera makes images of the sample in the vial.

According to yet a further embodiment the at least one radiation system comprises a ring light around the camera so as to irradiate the sample in the vial from the same direction as the camera is arranged for making images of the sample in the vial.

According to a further embodiment the at least one radiation system is irradiating the vial with an angle with respect to the direction the camera is making images from the sample in the vial.

According to a further embodiment of the invention the apparatus is provided with a comparing system for comparing a radiation intensity of radiation received from the sample in the vial with a threshold value. The apparatus may be provided with a radiation adjustment system to adjust an intensity of the radiation irradiated by the at least one radiation system if the radiation intensity received from the sample is not equal to the threshold value.

According to a further embodiment of the invention the apparatus may be provided with two radiation systems, the apparatus being constructed and arranged so that the camera detects radiation traversing through the vial from a first of the two radiation systems and detects radiation diffuse reflected from the sample in the vial from a second of the two radiation systems and the apparatus is provided with a radiation system switching device for switching between irradiation by the first radiation system and irradiation by the second radiation system. The apparatus may be provided with: a comparing system for comparing a radiation intensity of radiation received from the sample in the vial with a threshold value, wherein the switching device switches from irradiation by the first radiation system to irradiation by the second radiation system if the irradiation intensity of radiation traversing through the vial is below the threshold value. If the sample becomes so turbid that there is hardly any radiation traversing through the sample the switching device may switch from backside irradiation from the first radiation system to front side irradiation from the second radiation system.

According to an embodiment of the invention the analyser may be provided with an image processing module for processing of the images made by the camera, the image processing module being provided with software for image analysis of the particle shape and size distribution of particles in the sample in the vial.

According to an embodiment of the invention the apparatus comprises a magnetic or mechanical drive for driving a stirrer in the vial.

According to a further embodiment the telecentric lens may be constructed and arranged as an object-space telecentric lens creating images of the same size for objects at any distance in the sample. Alternatively the telecentric lens may be constructed and arranged as an image-space telecentric lens creating images of the same size regardless of the distance between the lens and the detector. The telecentric lens may be double telecentric.

According to a further embodiment of the invention the invention relates to method of analysing a sample comprising:

providing a vial with a sample releasable to a holder;

irradiating the sample in the vial with radiation;

recording images of the sample in the vial with a camera and analysing the images with an image processing module so as to determine information about the particle size and/or size distribution of particles in the sample.

According to an embodiment of the invention the method further comprises using the information about the particle size and/or size distribution of particles in the sample for changing reaction conditions in the vial. Changing the reaction conditions of the vial may comprise heating or cooling of the vial.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a schematic top view on a sample analysis apparatus according to a first embodiment of the invention;

FIG. 2 depicts a schematic top view on a sample analysis apparatus according to a second embodiment of the invention;

FIG. 3 depicts a schematic top view on a sample analysis apparatus according to a third embodiment of the invention; and,

FIG. 4 depicts a three dimensional view on a holder constructed for use in a sample analysis apparatus according to the invention.

### DETAILED DESCRIPTION OF THE INVENTION

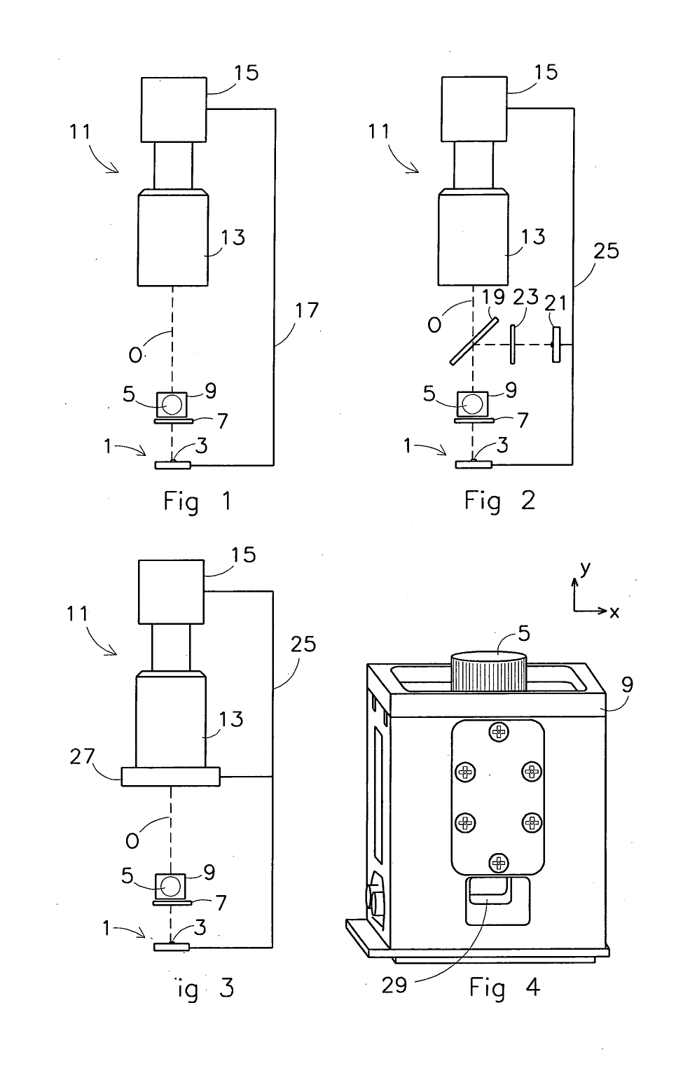

FIG. 1 schematically depicts a top view on a sample analysis apparatus according to a first embodiment of the invention. The apparatus comprises a radiation system 1 configured to irradiate a sample in a vial 5. The radiation system 1 may comprise a radiation source or it may receive its radiation from elsewhere, for example by a fibre. The radiation source may be a light emitting diode (LED) 3. An advantage of an LED is that the LED 3 does not generate much heat, which may influence the sample in the vial 5. Another advantage of a LED is that it may generate irradiation with a narrow bandwidth. The user may select the LED with a certain specific wavelength which is advantageously for a certain sample. The wavelength irradiated by the radiation system may be between 300 and 3000 nm, which includes ultraviolet radiation to deep infrared radiation.

The radiation system 1 may provide pulsed irradiation. The sample in the vial 5 may comprise moving particles and by providing pulsed irradiation stand still images can be made from the particles in the sample. Alternatively, the apparatus may be provided with a shutter to make stand still images but because a shutter comprises moving parts pulsed irradiation is more advantageous.

The radiation system 1 irradiates the sample via a diffuser plate 7. The function of the diffuser plate 7 is to make the irradiation of the vial 5 more uniform. A holder 9 for releasable holding the vial 5 is provided with a hole for receiving the vial 5 and with an opening for the irradiation to irradiate the vial 5 and with an opening for the camera to make images of the sample in the vial 5. The opening within the holder is along the optical axis O of the camera 11. The holder 9 comprises a temperature control system with a thermometer for controlling the temperature of the vial 5. The temperature control system may comprise a heater for heating the vial and/or a cooler for cooling the vial within a temperature range from −25° C. until 180° C.

The camera 11 which is a part of an analyser comprises a lens system 13 and a detector 15. The lens system 13 provides a telecentric image of a part of the sample in the vial 5 on the detector 15 so that the magnification of the particles in the sample is not dependent on the position of the particles in the image field. The camera comprises a lens and a detector and the lens provides a telecentric image of a part of the sample on the detector. As an alternative, cheaper non-telecentric optics may be used for the lens system. The detector 15 may be a Charge coupled device (CCD) array and detects an image of the particles in black and white or in full colour.

Telecentric lenses have the same magnification at all distances. Because their images have constant magnification and geometry, telecentric lenses are suitable for making images of particles that are moving within a vial and are not at a constant distance. The telecentric lens is also less sensitive for lens effects due to the curvature of the vial.

Telecentric lenses may be object-space telecentric, image space telecentric or double sided telecentric. An object-space telecentric lens creates images of the same size for objects at any distance in the sample and has constant angle of view across the entire field of view. An object or particle that is too close or too far from the lens may still be out of focus, but the resulting blurry image will be the same size as the correctly-focused image would be. Object-space telecentric lenses have an entrance pupil infinitely far behind the lens; this is, if you look in the front, the apparent aperture is very far away.

An image-space (or image-side) telecentric lens produces images of the same size regardless of the distance between the lens and the detector. This allows the lens to be focused to different distances without changing the size of the image. Image-space telecentric lenses have an exit pupil infinitely far in front of the lens; that is, if you look in the back of the lens, the apparent aperture is very far away. At the detector or image sensor, all of the principal rays from these lenses hit “straight on”, or at zero angle of incidence. This property minimizes any angle-of-incidence dependence of the detector, or of any beam-splitter prism assembly behind the lens, such as a color separation prism in a three-CCD camera.

Lenses that are double sided telecentric are object-space telecentric and image-space (or image-side) telecentric and have magnification that is more precisely constant than those that are only object-side telecentric, because the principal ray intercept position on the detector doesn't change as well. This property allows precise measurement of objects regardless of position even better.

The camera may be provided with a diaphragm which may be opened completely. The depth of focus will be between 1 and 1.5 mm and the shutter speed may be between 5 and 50 millisecond, preferably 20 milliseconds and more preferably 10 milliseconds.

The camera 11 may be provided with a radiation intensity measurement system. The radiation intensity measurement system may be a separate unit or may form part of the detector 15. If the intensity measured by the radiation intensity measurement system of the radiation received through the vial is below a certain threshold value the radiation system 1 may be adjusted via a feed back loop 17 to irradiate more radiation. The detector may be provided with a comparing system to compare the radiation intensity of radiation received from the sample with the threshold value. It may also be advantageous to keep the back-ground at a constant intensity, e.g. grey scale value. It is therefore advantageous to measure the background intensity and to compare the background intensity with a threshold value and to increase the background illumination if the background intensity gets lower than the threshold and to decrease the background illumination if the background intensity gets higher than the threshold.

FIG. 2 depicts a schematic top view on a sample analysis apparatus according to a second embodiment of the invention. The second embodiment is equal to the first embodiment accept for the items described below.

In the second embodiment of the invention a semi-transparent mirror 19 is provided in the optical path of the camera 11 having an optical axis O. If the vial 5 is irradiated by the first radiation system 1 the radiation is traversing through the vial 5 and the semi-transparent mirror 19 to the camera 11. This may be called back lighting.

The camera 11 may be provided with a radiation intensity measurement system and if the radiation received by the camera 11 is below a certain threshold the first radiation system 1 may be adjusted to irradiate more radiation to the vial 5. If however, the sample in the vial 5 becomes so turbid that adjusting the radiation intensity of the first radiation system 1 is not sufficient anymore, a radiation system switching device for switching between irradiation by the first radiation system 1 and irradiation by a second radiation system may be used. The switching device may be provided to the sensor 15 and may switch off the first radiation system 1 and switch on the second radiation system comprising a second light emitting diode 21 and a second diffuser plate 23 via the light control connection 25. The semitransparent mirror 19 will reflect the irradiation of the second radiation system to the sample 5 from the same direction as the camera 11 is looking at the vial 5. This may be called front lighting. The irradiation diffuse reflected by the sample in the vial 5 may be reflected through the semitransparent mirror and will be recorded by the camera 15. Front lighting of the sample in the vial is advantageous if the turbidity of the sample in the vial is high.

FIG. 3 depicts a schematic top view on a sample analysis apparatus according to a third embodiment of the invention. The third embodiment is equal to the second embodiment accept for the items described below. The third embodiment discloses an alternative way of front lighting of the sample in the vial.

If the sample in the vial 5 becomes so turbid that adjusting the radiation intensity of the first radiation system 1 is not sufficient anymore, a radiation system switching device for switching between irradiation by the first radiation system 1 and irradiation by a second radiation system 27 may be used. The switching device may be provided to the sensor 15 and may switch off the first radiation system 1 and switch on the second radiation system 27 via the light control connection 25. The second radiation system 27 may be provided with a light surrounding the opening of the camera 11, which provides front lighting to the sample in the vial 5. The irradiation diffuse reflected by the sample in the vial 5 will be recorded by the camera 11. Front lighting of the sample in the vial is advantageous if the turbidity of the sample in the vial is high. The front lighting according to the third embodiment of the invention is cost effective since no semitransparent mirror is needed. The front lighting may also be accomplished by other radiation systems.

In the second and third embodiment according to the invention the front lighting is disclosed as an alternative for back lighting, however it must be understood that the front lighting may also be used in an analysis apparatus according to the invention without back lighting.

FIG. 4 depicts a three dimensional view on a holder constructed for use in a sample analysis apparatus according to the invention. The holder 9 is provided with a hole for releasable receiving the vial 5 (as here depicted only the top of the vial is visible). The holder 9 is provided with an opening 29 and the irradiation of the first radiation system may traverse through the opening 29, through the vial 5 and via the opening on the other side of the holder to the camera. The holder 9 may be provided with a temperature control system with a thermometer, a cooler and heater for controlling the temperature of the vial in the holder. The holder 9 may be provided with electromagnets which are activated so as to rotate a magnet which may be connected to a stirrer in the vial so as to stir the sample in the vial 5.

The camera may be connected to a TV or computer screen so as to provide images of the sample on the screen. The sample analysis apparatus may comprises an image processing module for processing of the images made by the camera. The image processing module may have software for image analysis of the particle shape and size distribution of particles in the sample in the vial. The information about particle size and size distribution may be used for growing crystals. This may be done using a phenomena called Oswald ripening. This phenomena may be used if large crystals need to be grown. If the image processing unit detects crystals that are growing when the temperature is slowly increasing the reaction may be reversed by cooling until only a view big crystals are left. By then heating the sample again the crystals will grow again but the bigger crystals are growing faster. By repeating this method large crystals may be grown. The sample analysis apparatus according to the invention makes the growing of crystals a lot easier by providing real time images and data of the crystallisation process in the vial. In the above example heating and cooling were used for initiating and reversing the crystallisation process, however any kind of habit changing may be used to initiate or reverse the crystallisation process. For example, the stirring speed may be adjusted.

The sample analysis apparatus may be provided with a Raman spectroscopy branch, for measuring the Raman spectroscopy of the sample in the vial simultaneously with the image of the sample in the vial. Typically, the sample will be illuminated with a laser beam and radiation from the illuminated spot is collected with a lens and sent through a monochromator. Wavelengths close to the laser line are filtered out while the rest of the collected light is dispersed onto a detector forming the Raman scattering. Alternatively, light emitting diodes (LED's) may be used for illumination of the sample in the vial. LED's may be advantageous for Raman scattering because the light has a narrow bandwidth.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetical or optical disk) having such a computer program stored therein.

The descriptions above are intended to be illustrative, not limiting. Thus it will be apparent to one skilled in the art that modifications may be made to the invention as described without departing from the scope of clauses set out below.

1. A sample analysis apparatus comprising:
at least one radiation system constructed and arranged to irradiate the sample in a vial;
an analyser provided with a camera constructed and arranged to analyse the radiation received from the sample in the vial, wherein the apparatus is provided with a holder constructed and arranged to releasable hold the vial and provided with an optical path for the radiation system to irradiate the sample and for the camera to make images of the sample, wherein the camera comprises a telecentric lens and a detector.

2. The apparatus according to claim 1, wherein the at least one radiation system comprises a radiation source.

3. The apparatus according to claim 2, wherein the radiation source comprises a light emitting diode.

4. The apparatus according to claim 1, wherein the at least one radiation system irradiates the sample in the vial with pulsed irradiation.

5. The apparatus according to claim 1, wherein the at least one radiation system comprises a diffuser for ensuring a uniform irradiation of the sample in the vial.

6. The apparatus according to claim 1, wherein the holder comprises a temperature control system provided with a thermometer for controlling the temperature of the vial.

7. The apparatus according to claim 1, wherein the apparatus comprises a temperature control system provided with a heater for heating the vial and/or a cooler for cooling the vial.

8. The apparatus according to claim 1, wherein the holder is provided with a hole for releasable receiving the vial and the at least one radiation system and the camera are constructed and arranged opposite each other with the hole in between so that the radiation system is irradiating the camera with radiation traversing through the vial in the hole.

9. The apparatus according to claim 1, wherein the holder is provided with a hole for releasing and receiving the vial and the at least one radiation system and the camera are arranged on the same side of the hole and the at least one radiation system is arranged for irradiating the sample in the vial from the same direction as the camera is arranged for making images of radiation diffuse reflected form the sample in the vial.

10. The apparatus according to claim 9, wherein the at lease one radiation system comprises a semitransparent mirror which is arranged between the camera and the hole so as to irradiate the sample in the vial from the same direction as the camera makes images of the sample in the vial.

11. The apparatus according to claim 9, wherein the at least one radiation system comprises a ring light around the camera so as to irradiate the sample in the vial from the same direction as the camera is arranged for making images of the sample in the vial.

12. The apparatus according to claim 9, wherein the at least one radiation system is irradiating the vial with an angle with respect to the direction the camera is making images from the sample.

13. The apparatus according to a claim 1, wherein the apparatus is provided with a comparing system for comparing a radiation intensity of radiation received from the sample in the vial with a threshold value.

14. The apparatus according to claim 13, wherein the apparatus is provided with a radiation adjustment system to adjust an intensity of the radiation irradiated by the at least one radiation system if the radiation intensity received from the sample is not equal to the threshold value.

15. The apparatus according to claim 1, wherein the apparatus is provided with two radiation systems, the apparatus being constructed and arranged so that the camera detects radiation traversing through the vial from a first of the two radiation systems and detects radiation diffuse reflected from the sample in the vial from a second of the two radiation systems and the apparatus is provided with a radiation system switching device for switching between irradiation by the first radiation system and irradiation by the second radiation system.

16. The apparatus according to claim 15, wherein the apparatus is provided with:
a comparing system for comparing a radiation intensity of radiation received from the sample in the vial with a threshold value, wherein the switching device switches from irradiation by the first radiation system to irradiation by the second radiation system if the irradiation intensity of radiation traversing through the vial is below the threshold value.

17. The apparatus according to claim 1, wherein the analyser comprises an image processing module for processing of the images made by the camera, the image processing module being provided with software for image analysis of the particle shape and size distribution of particles in the sample in the vial.

18. The apparatus according to claim 1, wherein the apparatus comprises a magnetic or mechanical drive for driving a stirrer in the vial.

19. The apparatus according to claim 1 wherein the telecentric lens is constructed and arranged as an object-space telecentric lens creating images of the same size for objects at any distance in the sample.

20. The apparatus according to claim 1 wherein the telecentric lens is constructed and arranged as an image-space telecentric lens creating images of the same size regardless of the distance between the lens and the detector.

21. The apparatus according to claim 1 wherein the telecentric lens is double telecentric.

22. A method of analysing a sample comprising:
providing a vial with a sample releasable to a holder;
irradiating the sample in the vial with radiation;
recording images of the sample in the vial with a camera and analysing the images with an image processing module so as to determine information about the particle size and/or size distribution of particles in the sample.

23. The method according to claim 22, further comprising using the information about the particle size and/or size distribution of particles in the sample for changing reaction conditions in the vial.

24. The method according to claim 23, wherein changing the reaction conditions of the vial comprises heating or cooling of the vial.
